(19) United States
(12) Patent Application Publication
(10) Pub. No.: US 2026/0193882 A1
(43) Pub. Date: Jul. 9, 2026

(54) Insert

(71) Applicant: Japan Life Co., Ltd.,, Tokyo (JP)

(72) Inventors: Hiroshi IWASHITA, Tokyo (JP); Takashi YAMAMOTO, Tokyo (JP)

(21) Appl. No.: 19/380,014

(22) Filed: Nov. 5, 2025

(30) Foreign Application Priority Data
Jan. 8, 2025 (JP) 2025-002910

(51) Int. Cl. E04B 1/41; F16B 33/00

(52) U.S. Cl. CPC E04B 1/4121; F16B 33/002

(57) ABSTRACT

In order to prevent the loosening of a screw member of an insert, an opening portion of an accommodation hole is provided in the distal end portion of an insert body embedded in a concrete structure, and a first female screw is formed in the base end portion of the insert body. A first male screw which screws into the first female screw is provided at one end portion of the fastening screw member, and a second male screw provided at the other end portion of the fastening screw member screws into a second female screw provided in the nut, and installation equipment is fastened to the concrete structure by the nut. One of the first male screw and the second male screw is a right screw, and the other is a left screw.

### CROSS-REFERENCE TO RELATED APPLICATIONS

This application claims priority from Japanese Patent Application No.2025-002910 filed on January 8, 2025. The entire contents of which are hereby incorporated by reference into this application.

### TECHNICAL FIELD

The present invention relates to an insert embedded in a concrete structure in order to secure installation equipment such as a processing machine to a concrete construction such as a concrete slab.

### TECHNOLOGICAL BACKGROUND

An insert, which is a type of concrete anchor, is used to secure a processing machine such as a pressing machine, a laser cutter, or a lathe to a concrete slab, which is a base plate made of concrete. An insert is also used to secure a suspended item such as a drainpipe, a gutter, or scaffolding to a bridge made of concrete. Further, an insert is also used to secure an auxiliary device such as a jet fan for exhaustion or an exhaust duct to the inner surface of a tunnel made of concrete.

The insert for securing installation equipment such as a processing machine, a suspended item, or an auxiliary device to a concrete structure as described above is embedded in a concrete construction as a type of anchor member.

Patent document 1 discloses an insert for securing pipework, which is installation equipment, to a wall of a structure such as a concrete building. The insert has an insert body which is embedded in the wall of the structure, and by fastening a mounting tool which is secured to the pipework to the insert body with a fastening screw member, the pipework is secured to the wall, and the fastening screw member is embedded in the structure along with the insert body.

### RELATED DOCUMENTS

Patent Document 1: JP 2005-180016 A

### SUMMARY OF THE INVENTION

### Problem to be solved by the invention

When installation equipment such as a suspended item vibrates, that vibration is carried to the mounting tool secured to the installation equipment. Accordingly, it is assumed that when a long time passes after securing the installation equipment to the concrete structure, the screw member of the insert loosens due to the vibration of the mounting tool. For this reason, the amount of time between maintenance checks of the installation equipment which is secured to the concrete structure cannot be extended. Even if the installation equipment vibrates, if the loosening of the screw member can be prevented, then the reliability of the insert can improve and the amount of time between maintenance checks of the installation equipment can be extended.

The present invention has been made in view of the above technical background and aims to provide technology capable of preventing the loosening of screw portions of an insert.

### Means for solving the problem

In order to resolve the problem above, an embodiment of the insert of the present invention has an insert body which is embedded in a concrete structure, and in which an opening of an accommodation hole is provided at a distal end portion thereof, a fastening screw member which is provided with a first male screw at one end portion that joins with a first female screw provided at the base end portion of the insert body, and a nut which is provided with a second female screw that joins with a second male screw provided in another end portion of the fastening screw member. Additionally, one of the first male screw or the second male screw is a right screw, and the other is a left screw.

In addition, in an embodiment of the present invention, an engagement portion with which a rotation tool engages is provided on the other end portion of the fastening screw member in the invention.

In addition, in an embodiment of the present invention described in claim 3, the engagement portion has two engaging surfaces which are parallel to each other in the invention.

In addition, in an embodiment of the present invention, a cap is provided which is fitted to the base end portion of the insert body and closes the accommodation hole in the invention.

In addition, in an embodiment of the present invention, the cap has a cylindrical portion into which a female screw groove is dug by one end portion of the fastening screw portion in the invention.

In addition, in an embodiment of the present invention, the cap is formed of materials that have less strength than the fastening screw member in the invention.

In addition, in an embodiment of the present invention, the first male screw is a right screw, and the second male screw is a left screw in the invention.

In addition, in an embodiment of the present invention, a metal washer is provided and arranged between a mounting tool secured to the installation equipment and the nut, and the fastening ability of the nut is passed on to the mounting tool via the metal washer in the invention.

In addition, in an embodiment of the present invention, the metal washer is a conical washer in which the end surface not facing the mounting tool has a larger outer diameter than the diameter of the end surface facing the nut in the invention.

### Effect of the invention

According to an embodiment of the present invention, an insert body in which an accommodation hole is formed is provided, either one of a first male screw of a fastening member which screws into a first female screw of an insert body, or a second male screw of a fastening screw member which screws into a second female screw of a nut is a right screw, and the other is a left screw, thus loosening due to the insert body, the fastening screw member, and the nut vibrating together can be prevented.

According to an embodiment of the present invention, an engagement portion with which a rotating tool engages is provided in the fastening screw member, and by using the rotating tool to rotate the fastening screw member, the fasting screw member can be manually screwed to the insert body.

According to an embodiment of the invention, the engagement portion has two engaging surfaces which are parallel to each other, and the fastening screw member is rotated by a rotating tool such as a spanner.

According to an embodiment of the present invention, the accommodation hole of the insert body is closed by the cap, and concrete is prevented from entering the inner portion of the accommodation hole.

According to an embodiment of the present invention, the cap is provided with a cylindrical portion in which a female screw groove thereof is dug into by one end portion of the fastening screw member. This configuration allows the cap to prevent the fastening screw member from loosening.

According to an embodiment of the invention, the cap is formed of materials which have less strength than the fastening screw member, so by rotating the fastening screw member with respect to the insert body, the fastening screw member can be easily fastened to the insert body.

According to an embodiment of the invention, by making the first male screw a right screw, mass-produced products can be used as the insert body.

According to an embodiment of the invention, the fastening ability of the nut can be passed on to the mounting tool via the metal washer.

According to an embodiment of the present invention, the fastening ability of the nut can be evenly dispersed and passed on to the mounting tool by the conical washer.

### BRIEF DESCRIPTION OF THE DRAWINGS

FIGS. 1A, 1B, and 1C are cross-sectional views showing an insert relating to an embodiment of the present invention, FIG. 1A is a cross-sectional view showing an insert embedded in a concrete slab in order to secure a processing machine such as a pressing machine to the concrete slab, FIG. 1B is a cross-sectional view showing an insert embedded in a bridge made of concrete in order to secure a suspended item such as a drain pipe to the bridge, and FIG. 1C is a cross-sectional view showing an insert secured to a tunnel made of concrete in order to secure an auxiliary device such as an exhaust duct to the inner surface of the tunnel.

FIG. 2 is a perspective view showing a mounting member secured to a processing machine and an insert as shown in FIG. 1A.

FIG. 3 is a perspective view showing a mounting member secured to a suspended item and an insert as shown in FIG. 1B.

FIG. 4 is a perspective view showing a mounting member secured to an auxiliary device and an insert as shown in FIG. 1C.

FIG. 5 is a disassembled cross-sectional view of an insert relating to an embodiment of the present invention.

FIG. 6 is a cross-sectional view of an insert in a state in which installation equipment is secured to a concrete structure.

FIG. 7 is a plan view of FIG. 6.

### EMBODIMENTS

Hereinafter, exemplary embodiments of the present invention will be described in detail based on the drawings. In the drawings for describing the embodiments, the same components are denoted by the same reference numerals in principle, and repeated descriptions thereof will be omitted.

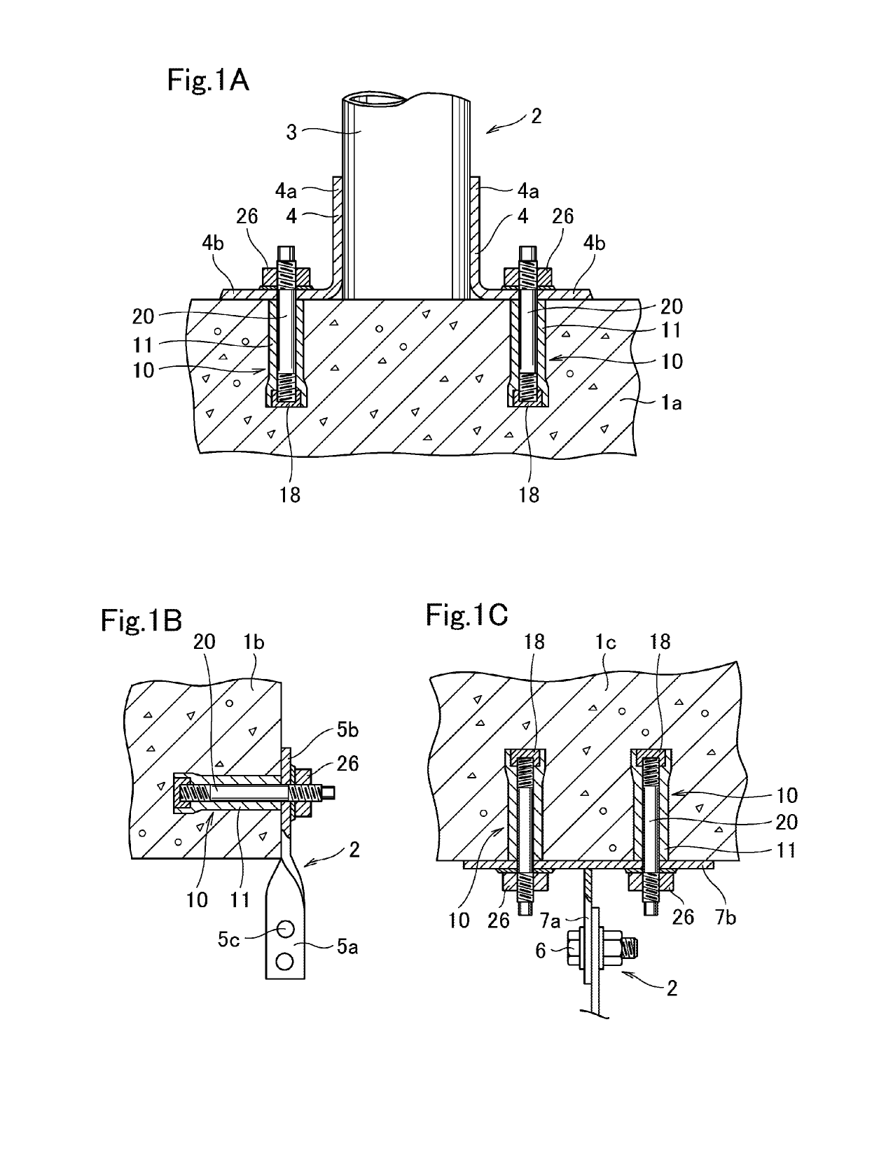

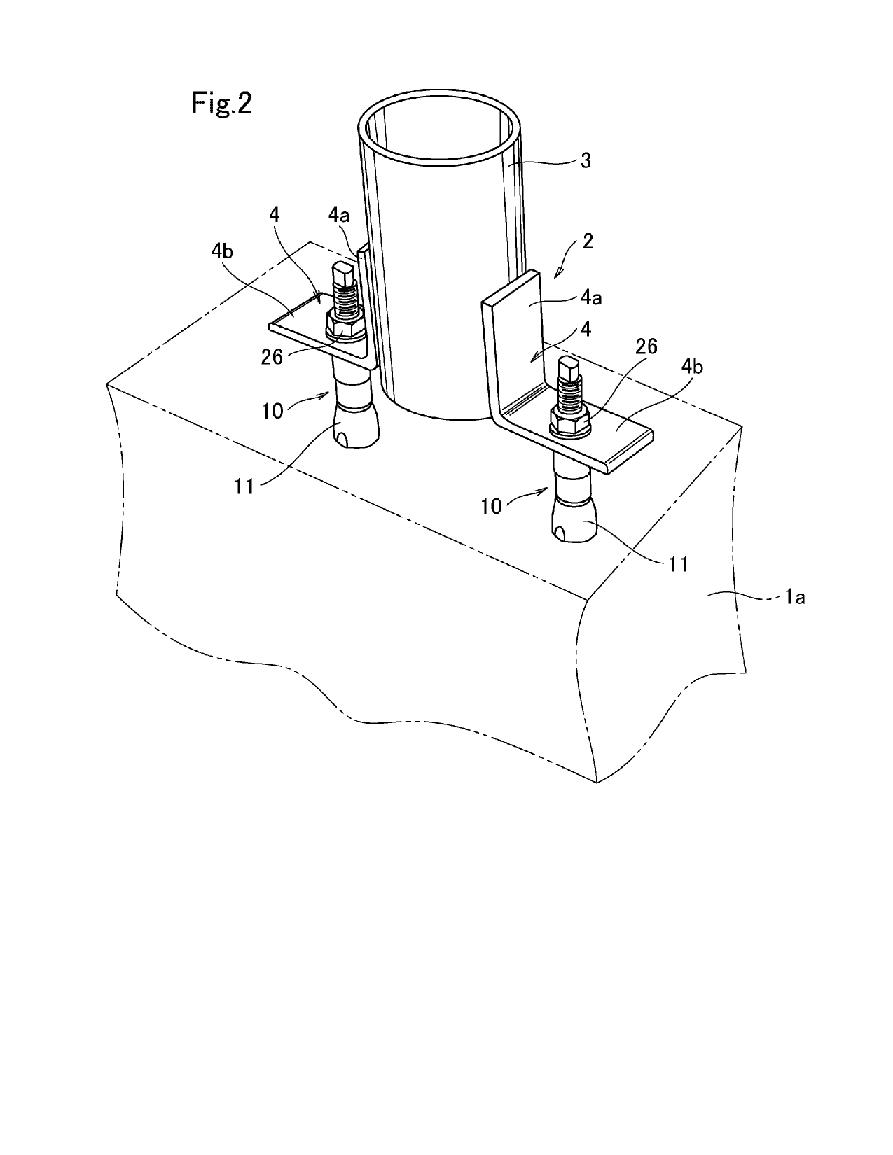

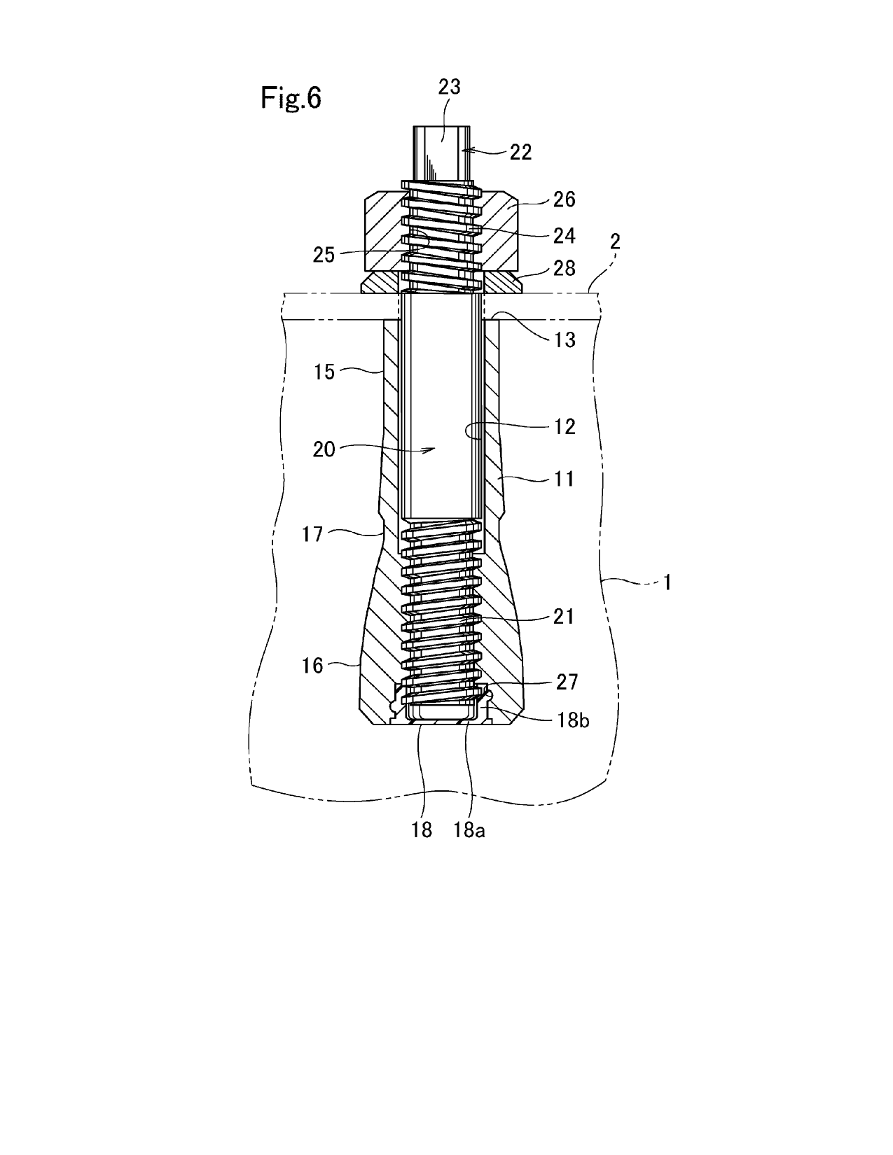

As shown in FIG. 1A and FIG. 2, a mounting tool 2 for securing a processing machine, which is a type of installation equipment, to the upper surface of a concrete slab 1a which is a concrete structure 1 (FIG. 6) has a cylindrical member 3 to which the processing machine is secured, and two legs 4 which are fixed to the cylindrical member 3. Each of the legs 4 have a fixed portion 4a which is welded and fixed to the cylindrical member 3, and a fastening portion 4b which is bent at a right angle with respect to the fixed portion 4a. The fastening portion 4b is fastened to the concrete slab 1a by two inserts 10 embedded in the concrete slab 1a.

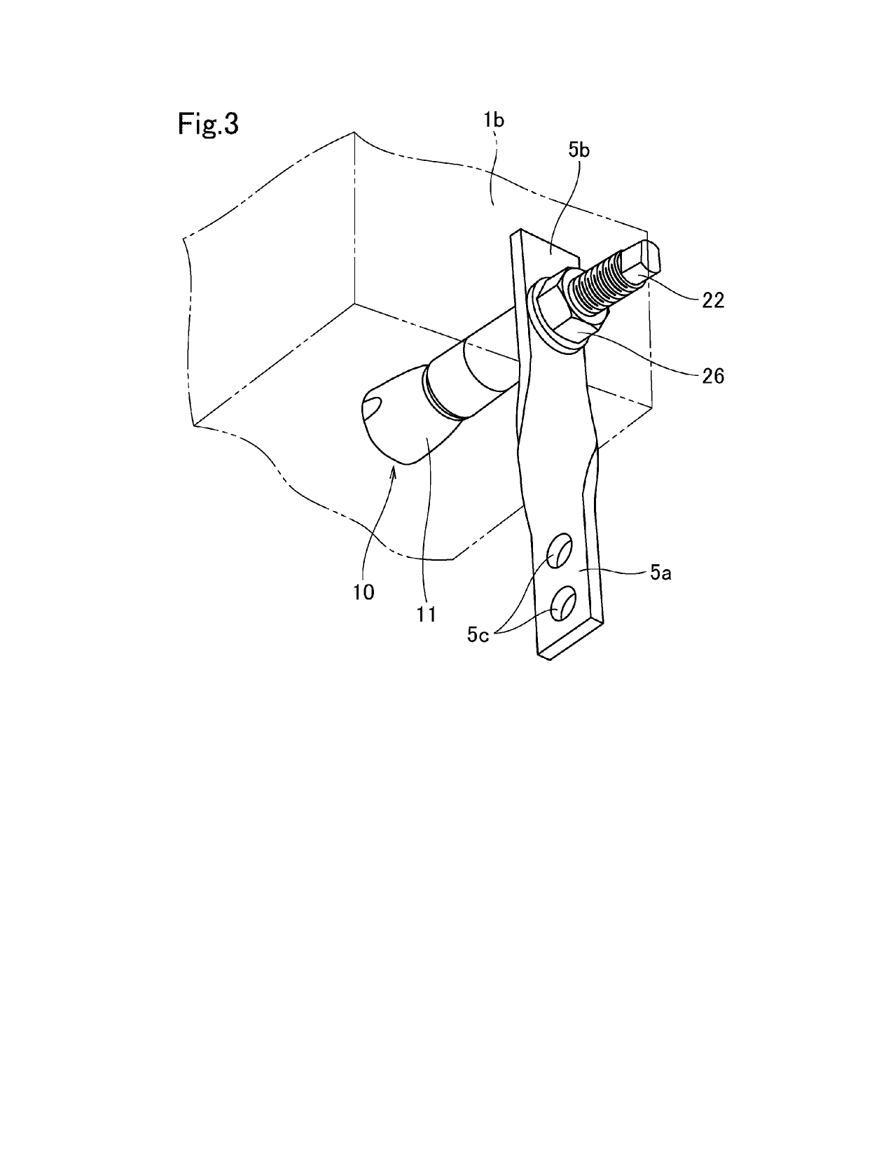

As shown in FIG. 1B and FIG. 3, the mounting tool 2 for securing a suspended item, which is a type of installation equipment, to a side surface of a bridge 1b has a fixed portion 5a to which the suspended item is mounted, and a fastening portion 5b which is bent at a right angle with respect to the fixed portion 5a. In the fixed portion 5a, a screw hole 5c is provided for securing the suspended item, and the fastening portion 5b is fastened to the bridge 1b by the insert 10 embedded in the bridge 1b.

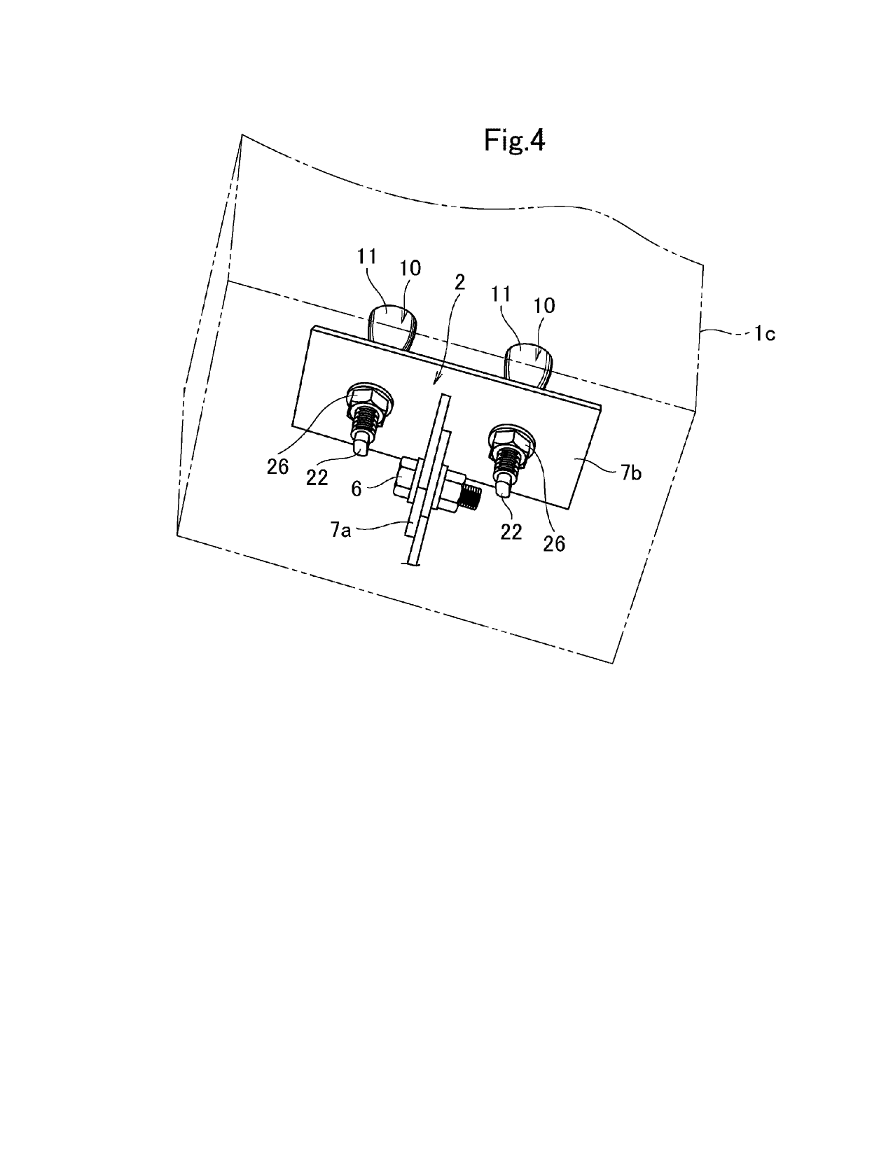

As shown in FIG. 1C and FIG. 4, the mounting member 2 for securing an auxiliary device, which is a type of installation equipment, to the inner surface of a tunnel 1 c has a fixed portion 7a to which the auxiliary device is mounted by a bolt 6, and a fastening portion 7b to which the fixed portion 7a is welded onto the outer surface thereof. The fastening portion 7b is fastened to the tunnel 1c by the two inserts 10 embedded in the tunnel 1c.

In FIG. 1A and FIG. 1C, two inserts 10 are shown embedded in a concrete structure, and in FIG. 1B, one insert is shown embedded in a concrete structure.

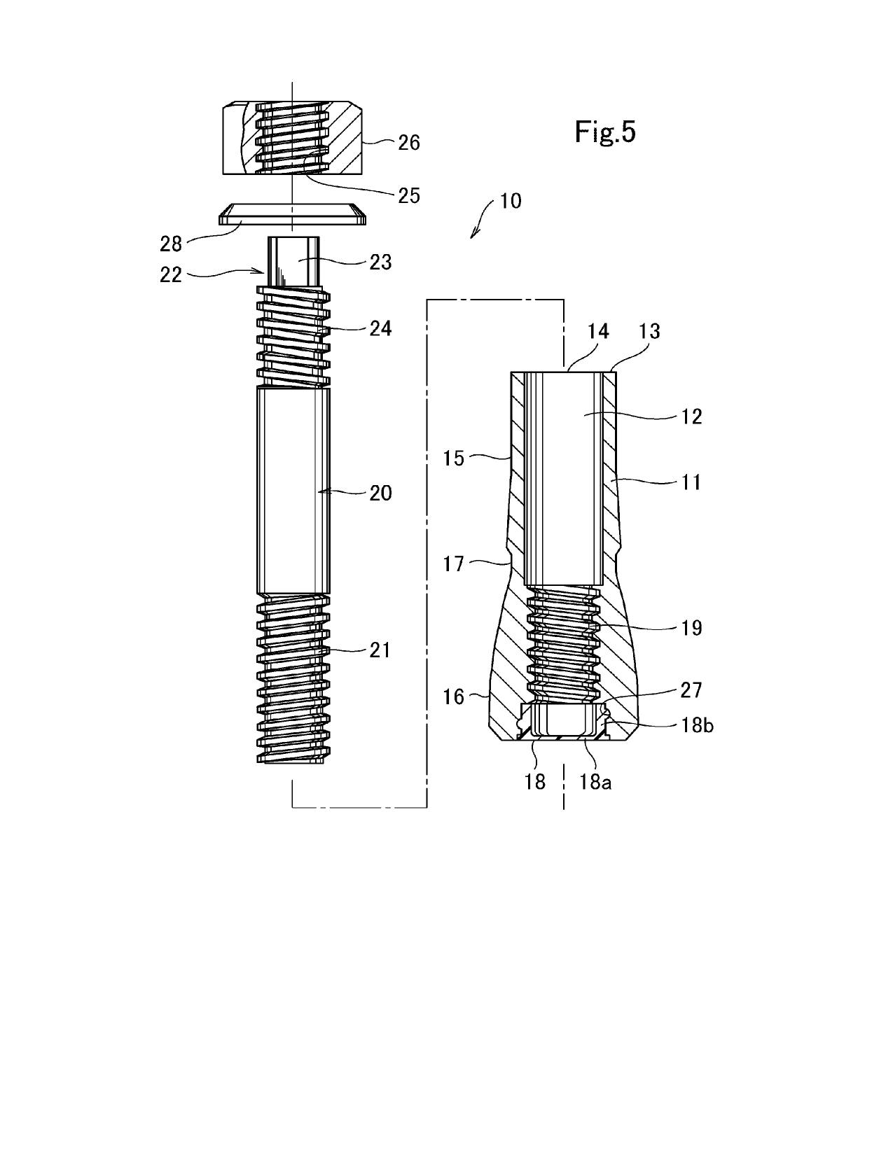

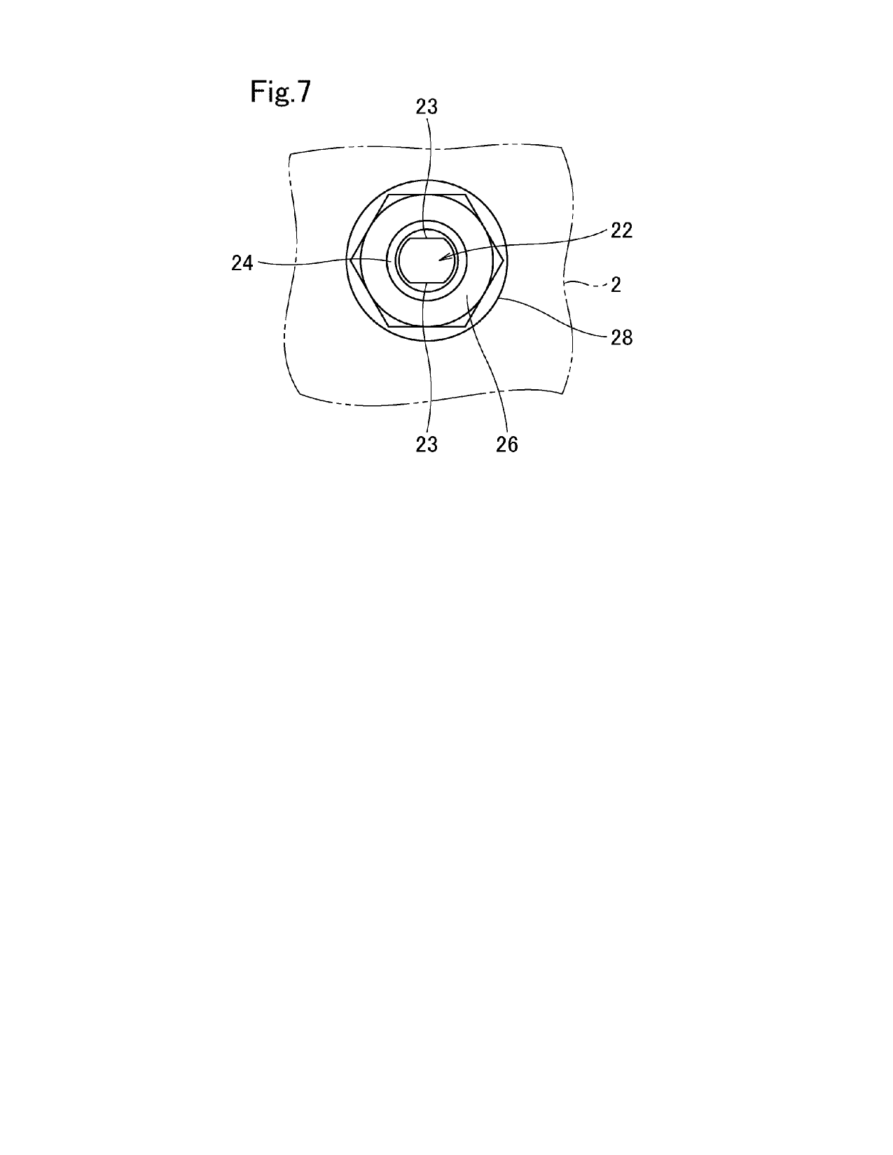

FIG. 5 is a disassembled cross-sectional view of an insert 10 relating to an embodiment of the present invention shown in FIG. 1 through FIG. 4. FIG. 6 is a cross-sectional view of an insert in a state in which installation equipment is secured to a concrete structure 1. FIG. 7 is a plan view of FIG. 6.

An insert 10 has an insert body 11 embedded in a concrete structure 1, and the insert body 11 is formed of ceramics such as alumina. In the insert body 11, an accommodation hole 12 is formed, and the accommodation hole 12 opens on the outer portion thereof with an opening portion 14 provided at a distal end surface 13 of the insert body 11.

The outer diameter of the distal end side portion of the insert body 11 is a nearly constant straight portion 15, and a bulging portion 16 having a larger diameter than the straight portion 15 is formed in the base end side portion, and a constricted portion 17 is formed between the bulging portion 16 and the straight portion 15. The insert body 11 digs into and is firmly embedded in the concrete structure 1 by the bulging portion 16 and the constricted portion 17.

When constructing the concrete structure 1, the insert body 11 is preliminarily secured to a formwork and embedded in the concrete structure 1 by casting concrete into the formwork. In a state in which the insert body 11 is embedded, the distal end surface 13 is exposed on the outer surface of the concrete structure 1.

As shown in FIG. 1A and FIG. 2, when the insert 10 is used to secure a processing machine to the concrete slab 1a, the insert body 11 is embedded in the concrete slab 1a. As shown in FIG. 1B and FIG. 3, when the insert 10 is used to secure a suspended item to a bridge, the insert body 11 is embedded in the bridge 1b. Further, as shown in FIG. 1C and FIG. 4, when the insert 10 is used to secure an auxiliary device to a tunnel, the insert body 11 is embedded in the tunnel.

In the base end portion of the insert body 11, a cap 18 for blocking the accommodation hole 12 is secured, and when embedding the insert body 11 into a concrete structure 1 such as a concrete slab 1a, the concrete casted into the formwork is prevented from overflowing into the accommodation hole 12 by the cap 18.

The cap 18 is formed of synthetic resin such as nylon which is a material having less strength than the material of the insert body 11 and has an endplate portion 18a which blocks the accommodation hole 12, and a cylindrical portion 18b which fits with the inner circumferential surface of the accommodation hole 12. An engagement portion 18c is provided on the outer circumferential surface of the cylindrical portion 18b and protrudes in a radial outward direction of the cylindrical portion 18b, the engagement portion 18c engages with a groove formed in the insert body 11, and the cap 18 is prevented from being removed from the insert body 11.

In the base end portion of the insert body 11, a female screw 19 is provided as a first female screw and is arranged on the distal end portion side of the insert body 11 relative to the cap 18.

The insert 10 has a fastening screw member 20 which assembles into the accommodation hole 12 of the insert body 11. In one end of the fastening screw member 20, a male screw 21 is provided as a first male screw which screws into, or in other words engages with, the female screw 19.

The male screw 21 is a right screw, and when the fastening screw member 20 is rotated in the right direction when looking from an axial direction, the fastening screw member 20 moves in a direction penetrating the female screw 19, and when rotated in the opposite direction, moves in a direction away from the female screw 19. The male screw 21 is a single thread screw in which the shape of the screw threads is trapezoidal.

An engagement portion 22 with which a rotating tool such as a spanner engages is provided on another end portion of the fastening screw member 20, and by rotating the fastening screw member 20 with the rotating tool, the male screw 21 is screwed into the female screw 19 of the insert body 11. The engagement portion 22, as shown in FIG. 7, has two engaging surfaces 23 which are parallel to each other, and the rotating tool engages with engaging surfaces 23. Further, as a cross-sectional shape of the engagement portion 22, a square shape having four engaging surfaces 23 or a hexagonal shape having six engaging surfaces 23 may be used.

On the other end portion of the fastening screw member 20, a male screw 24 is provided as a second male screw and is arranged further on the inner side in the axial direction than the engagement portion 22. In the fastening screw member 20, a nut 26 is fitted which is provided with a female screw 25 as a second female screw into which the male screw 24 screws. By screwing the male screw 24 into the female screw 25 and fitting the nut 26 to the fastening screw member 20, installation equipment such as a processing machine is fastened to the concrete structure 1.

The insert 10 has an insert body 11, a fastening screw member 20, and a nut 26, and the fastening screw member 20 assembles into the insert body 11 preliminarily embedded in the concrete structure 1 and is embedded in the concrete structure 1 along with the insert body 11.

The male screw 24 is a left screw, and when the nut 26 is rotated in the left direction looking from the axial direction, the nut 26 moves in a direction moving toward the male screw 24, and when rotated in the opposite direction, the nut 26 moves in a direction away from the male screw 24. The male screw 24, like the male screw 21, is a single thread screw in which the shape of the screw threads is trapezoidal.

The fastening screw member 20 is preliminarily inserted into the accommodation hole 12 of the insert body 11 and the male screw 21 screws into the female screw 19. At this time, the cap 18 is formed of materials having less strength than the material of the fastening screw member 20, so as shown in FIG. 6, the end portion of the male screw 21 of the fastening screw member 20 digs into the cylindrical portion 18b, and a female screw groove 27 is formed in the cylindrical portion 18b of the cap 18. By this, when the fastening screw member 20 is secured to the insert body 11, the fastening screw member 20 and the insert body 11 are firmly stuck together and joined, and the cap 18 for preventing the flow of concrete into the accommodation hole 12 also functions to prevent the loosening of screws.

In FIG. 6, a concrete structure such as a concrete slab 1a is shown by reference numeral 1, and a state in which a mounting tool 2 which is secured to installation equipment is fastened by a nut 26.

When using the insert 10 to secure installation equipment to the concrete structure 1, as shown in FIG. 6, in a state in which the mounting tool 2 secured to the installation equipment abuts the outer surface of the concrete structure 1 along with abutting the distal end surface 13 of the insert body 11, the female screw 25 of the nut 26 screws into the male screw 24 of the fastening screw member 20 and the nut 26 is assembled into the fastening screw member 20.

A conical washer 28 is fitted between the nut 26 and the mounting tool 2, and the fastening ability of the nut 26 is passed on to the screw engagement surface of the male screw 24 and the female screw 25 and is also passed on to the mounting tool 2 via the conical washer 28.

The outer surface of the conical washer 28 abuts against the nut 26, and the inner surface of the conical washer 28 abuts against the distal end surface 13 of the insert body 11 via the mounting tool 2. Therefore, the fastening ability of the nut 26 is passed on to the distal end surface 13 via the conical washer 28 and the mounting tool 2, and the mounting tool 2 of the installation equipment is firmly secured to the insert 10.

The end surface of the conical washer 28 facing the mounting tool 2 has a larger diameter than the other end surface of the conical washer 28 facing the nut 26. Therefore, the fastening ability of the nut 26 in the axial direction can be evenly dispersed in a direction other than the radial direction, and the loosening of the nut 26 can be prevented.

In a state in which installation equipment is secured to the insert 10, the male screw 21 of the fastening screw member 20 which is a right screw is screwed into the female screw 19 of the insert body 11, and the male screw 24 which is a left screw is screwed into the female screw 25 of the nut 26. Accordingly, due to vibrations and the like of the mounting tool 2 of the installation equipment and the concrete structure 1, even if external force is applied from a direction which loosens the nut 26 which is a left screw from the fastening screw member 20, or in other words, external force that is applied from a right rotational direction, that external force is in a direction in which the male screw 21 which is a right screw of the fastening screw member 20 moves toward the insert body 11.

By this, even if the installation equipment vibrates, the loosening of the fastening screw member 20 and the nut 26 can be reliably prevented.

The male screw 21 is a right screw, and the male screw 24 is a left screw, but even if the male screw 21 is a left screw and the male screw 24 is a right screw, the loosening of the screws can be reliably prevented. In other words, screws of both directions are screws in opposite directions from each other, so if one of the two male screws 21, 24 is a right screw, and the other is a left screw, and with the combination of a right screw and left screw, the loosening of the screws can be prevented and the amount of time between maintenance checks of the installation equipment can be extended.

The male screw 21 of the fastening screw member 20 digs into the cylindrical portion 18b of the cap 18 and forms the female groove 27 through the elastic deformation of the cylindrical portion 18b, thus aiming to prevent the loosening of the screws with the cap 18.

However, the male screw 21 of the fastening screw member 20 which screws into the female screw 19 of the insert 11 may, as a self-tapping screw, cut the female screw groove 27 into the cylindrical portion 18b of the cap 18. In addition, the self-tapping screw having a smaller diameter than the male screw 21 may protrude from the end surface of the male screw 21. In that case, the inner circumferential surface of the cylindrical portion 18b of the cap 18 may be set with a smaller diameter than the case illustrated.

The male screw 21 and the male screw 24 have the same diameter and the same pitch, but when the diameter and pitch of both screws are made different, they are prevented from rotating together in the same direction. As a result, loosening of the nut 26 and the fastening screw member 20 can be even more reliably prevented.

The present invention as made by the inventors has been explicitly described based on the embodiments. However, all aspects of the embodiments disclosed in this specification are examples, and the invention is not limited to the technology disclosed. That is to say, the technological scope of the present invention should not be interpreted in a limited manner based on the description of the embodiments above and should be interpreted in accordance with the description of the scope of the claims. The present invention includes technology equivalent to the technology described in the claims and all variations thereof, so long as they do not deviate from the gist of the scope of the claims.

For example, the installation equipment secured to the concrete structure 1 is not limited to processing machines and the like described above, and may be something capable of being secured to the insert 10 by a screw member. In addition, the male screws 21, 24 and the female screws 19, 25 are not limited to trapezoidal screws having trapezoidal cross-sectional screw threads, and maybe triangular screws having triangular cross-sectional screw threads, square screws having cross-sectional screw threads running close to a forward direction, or sawtooth screws which are a combination of square screws and triangular screws, or still further, may be round screws with rounded cross-sectional screw threads.

In addition, in the present embodiments, the insert body 11 is formed of ceramics, but may also be formed of materials other than ceramics, for example metals such as stainless steel, iron, or aluminum.

### INDUSTRIAL USE

The insert of the present invention has an insert body embedded in a concrete structure such as a concrete slab or a bridge made of concrete, and can be used for securing installation equipment to the concrete structure by a screw member screwed into the insert body.

### EXPLANATION OF REFERENCE NUMERALS

1: Concrete structure

1a: Concrete slab

1b: Bridge

1c: Tunnel

2: Mounting tool

3: Cylindrical member

4: Leg

4a: Fixed portion

4b: Fastening portion

5a: Fixed portion

5b: Fastening portion

6: Bolt

7a: Fixed portion

7b: Fastening portion

10: Insert

11: Insert body

12: Accommodation hole

13: Distal end surface

14: Opening portion

15: Straight portion

16: Bulging portion

17: Constricted portion

18: Cap

18a: Endplate portion

18b: Cylindrical portion

18c: Engagement portion

19: Female screw (first female screw)

20: Fastening screw member

21: Male screw (first male screw)

22: Engagement portion

23: Engaging surface

24: Male screw (second male screw)

25: Female screw (second female screw)

26: Nut

27: Female screw groove

28: Metal washer

1. An insert comprising:
an insert embedded in a concrete structure, in which an opening of an accommodation hole is provided at the distal end portion thereof;
a fastening screw member provided with a first male screw at one end portion thereof, which screws into a first female screw provided in the base end of the insert body; and
a nut provided with a second female screw which joins with a second male screw provided at the other end of the fastening screw member;
wherein one of the first male screw and the second male screw is a right screw, and the other is a left screw.

2. The insert according to claim 1, wherein an engagement portion with which a rotation tool engages is provided on the other end portion of the fastening screw member.

3. The insert according to claim 2, wherein the engagement portion has two engaging surfaces which are parallel to each other.

4. The insert according to claim 1, wherein a cap which closes the accommodation hole is fitted to the base end portion of the insert body.

5. The insert according to claim 4, wherein the cap has a cylindrical portion into which a female groove is dug by one end portion of the fastening screw member.

6. The insert according to claim 5, wherein the cap is formed of materials having less strength than those of the fastening screw member.

7. The insert according to claim 1, wherein the first male screw is a right screw, and the second male screw is a left screw.

8. The insert according to claim 1, wherein a metal washer is arranged between the mounting tool secured to the installation equipment and the nut, and the fastening ability of the nut is passed on to the mounting tool via the metal washer.

9. The insert according to claim 8, wherein the metal washer is a conical washer in which one end surface facing the nut has a larger outer diameter than the other end surface facing the mounting tool.
